(19) United States
(12) Patent Application Publication
(10) Pub. No.: US 2007/0040865 A1
(43) Pub. Date: Feb. 22, 2007

(54) Maintenance apparatuses for fluid injectors and fluid injection devices integrated therewith

(75) Inventors: Chung Cheng Chou, Taoyuan County (TW); Meng Wei Chen, Taipei City (TW)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/506,314

(22) Filed: Aug. 17, 2006

(30) Foreign Application Priority Data
Aug. 17, 2005 (TW) TW94128021

(51) Int. Cl. B41J 2/135

(52) U.S. Cl. 347/45

(57) ABSTRACT

Maintenance apparatuses for fluid injectors and fluid injection devices integrated therewith. The maintenance device comprises a compressor. A reservoir comprises a gas inlet hole, a gas outlet hole, and a liquid outlet hole, wherein the gas inlet hole connects the compressor via a gas pipeline. A nozzle is connected to the liquid outlet hole by a liquid pipeline. A wiping device comprises at least one wiping blade and a rail for the at least one wiping blade to slide on to maintain the nozzles of the fluid injector.

### BACKGROUND

The invention relates to fluid injection devices, and more particularly, to maintenance apparatuses for fluid injectors and fluid injection devices integrated therewith.

Fluid injection devices have been applied in information technology industries for decades. As micro-system engineering technologies have progressed, fluid injection devices have typically been employed in inkjet printers, fuel injection systems, cell sorting systems, drug delivery systems, print lithography systems and micro-jet propulsion systems. Among inkjet printers presently known and used, fluid injection devices can be divided into two categories: continuous mode and drop-on-demand mode depending on the fluid injection device.

According to the driving mechanism, conventional fluid injection devices can further be divided into thermal bubble driven and piezoelectric diaphragm driven fluid injection devices. Of the two, injection by thermally driven bubbles has been most successful due to its reliability, simplicity and relatively low cost. Printing quality depends on surface conditions of the printhead, nozzle aperture, droplet uniformity and droplet trajectory location. However, ink residue, dust and environmental micro-particles may be attached to the surface of the printhead. Moreover, when ink dries, the nozzle becomes clogged; therefore, maintenance of the fluid injector device is troublesome, and reliability of the device suffers. The difficulties may be eliminated by adding an ink drying prevention mechanism or a nozzle cleaning mechanism to the fluid injection device.

U.S. Pat. No. 5,559,540, the entirety of which is hereby incorporated by reference, discloses a maintaining method for an ink jet printhead by applying a hydrophobic substance. FIG. 1 is a schematic view showing a conventional method for maintaining an ink jet printhead. The printhead periodically moves back and forth on a rail 20 during injection of ink on a paper 16. When injection is finished, the printhead 12 returns to an original position and triggers the maintenance mechanism. As it returns, the printhead touches an additional motor 48 and rotating spindle 46 to activate an applicator 44. However, periodically applying hydrophobic material on the printhead as the applicator 44 glides back and forth on the rail not only causes over consumption of the hydrophobic material but cannot effectively remove ink residue, dust and micro-particles on the nozzle. Moreover, the applicator 44 is driven by additional motor 48 and rotation shaft 46 such that the fluid injection device becomes more intricate in construction, larger in size and higher in manufacturing cost.

### SUMMARY

Maintenance apparatuses for fluid injectors and fluid injection devices integrated therewith are provided. By employing fluid injection devices integrated maintenance apparatuses the surface of fluid injectors can be cleaned and wiped.

The invention provides a maintenance apparatus for a fluid injector comprising a compressor. A reservoir comprises a gas inlet hole, a gas outlet hole, and a liquid outlet hole. The gas inlet hole connects the compressor via a gas pipeline. A nozzle is connected to the liquid outlet hole by a liquid pipeline. A wiping device comprises at least one wiping blade and a rail on which the at least one wiping blade slides, thus maintaining the nozzles of the fluid injector.

The invention provides a fluid injection device integrating a maintenance apparatus for a fluid injector. A rail is provided for the back and forth movement of a fluid injector. A compressor is disposed at one end of the rail. A reservoir comprises a gas inlet hole, a gas outlet hole, and a liquid outlet hole. The gas inlet hole connects the compressor via a gas pipeline. A nozzle is connected to the liquid outlet hole by a liquid pipeline. A wiping device comprises at least one wiping blade and a rail on which the at least one wiper slides, thus maintaining nozzles of the fluid injector. A base receives the compressor, the gas pipeline, the liquid pipeline, the nozzle, and the wiping device.

### DESCRIPTION OF THE DRAWINGS

The invention can be more fully understood by reading the subsequent detailed description in conjunction with the examples and references made to the accompanying drawings, wherein:

FIG. 1 is a schematic view of a conventional method for maintaining an ink jet printhead;

FIG. 2 is a flow chart of an exemplary embodiment of methods of analyzing and maintaining fluid injectors;

FIG. 3 is a block diagram showing an embodiment of a fluid injection device integrating a maintenance apparatus for a fluid injector;

FIG. 4 is a schematic view of an embodiment of the maintenance apparatus of the invention;

FIG. 5 is a schematic view of connection between the compressor and the liquid reservoir of FIG. 4;

FIG. 6 is a schematic view of an embodiment of the fluid injection device integrating a maintenance apparatus; and

FIGS. 7A-7B are schematic views showing the steps of a compressor pushed by a fluid injector.

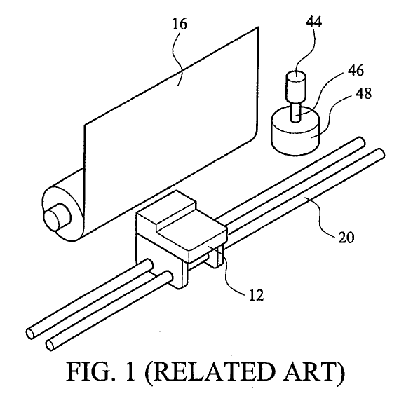

### DETAILED DESCRIPTION

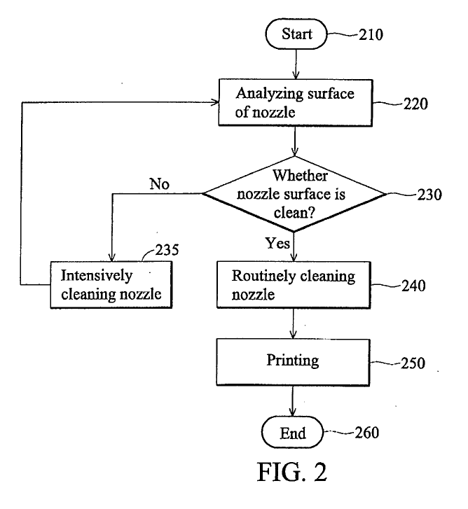

FIG. 2 is a flow chart of an exemplary embodiment of methods of analyzing and maintaining fluid injectors. After a fluid injector has periodically printed, if desired, maintenance 210 proceeds. Surface conditions 220 of the fluid injector are analyzed by a sensor. Judgments 230 on the surface conditions of the fluid injector are made accordingly. If the surface of the fluid injector is clean or uncontaminated, regular cleaning step 240 proceeds and printing step 250 follows until finished 260. If the surface of the fluid injector is contaminated or has stain residue, further maintenance or cleaning steps proceed.

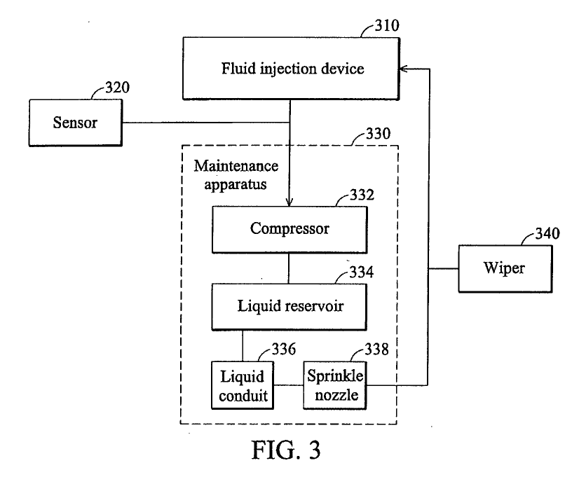

FIG. 3 is a block diagram showing an embodiment of a fluid injection device integrating a maintenance apparatus for a fluid injector. The fluid injection device comprises a fluid injector 310 and a maintenance apparatus 330. The maintenance apparatus 330 comprises a compressor 332 connecting a liquid reservoir 334 via a gas inlet. The liquid reservoir 334 comprises a gas inlet hole, a gas outlet hole, and a liquid outlet hole. A liquid pipeline 336 is provided with one end connected to the liquid reservoir 334 and the other end connected to a nozzle 338 which applies liquid on the fluid injector 310.

The fluid injection device integrating a maintenance apparatus further comprises at least one wiping blade 340 and a rail for the wiping blade 340 moving to maintain the surface of the fluid injector. A sensor 320 can further be provided to check the surface of the injector before maintaining the fluid injector.

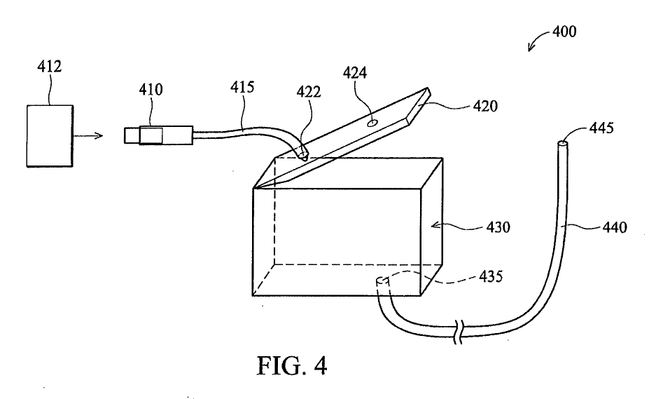

FIG. 4 is a schematic view of an embodiment of the maintaining apparatus of the invention. The fluid injection device 400 with integrated maintenance apparatus comprises a compressor 410, a liquid reservoir 430, and a nozzle 445. Compressor 410 connects a gas inlet hole 422 of the liquid reservoir 430 via a gas pipeline 415. Nozzle 445 connects a liquid outlet hole 435 of the liquid reservoir 430 via a liquid pipeline 440. An arrangement comprising compressor 410 connecting liquid reservoir 430 and further connecting nozzle 445 is thus provided. A cover 420 comprising a gas inlet hole 420 and gas outlet hole 424 is disposed on the liquid reservoir 430.

When the compressor 410 is pushed by an external force, such as compressed by the fluid injector 412, pressure is generated in the liquid reservoir and enforces the liquid spraying on the surface of the fluid injector.

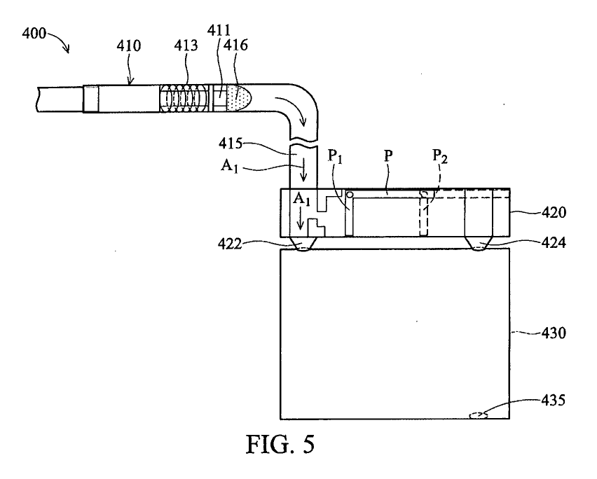

FIG. 5 is a schematic view of connection between the compressor 410 and the liquid reservoir 430 of FIG. 4. The arrangement a gas inlet hole 422, a gas outlet hole 424 and a sliding shield P is shown in detail in a cross-section of the cover 420. When the gas inlet hole 422 is pushed by pressure from the compressor 410, the sliding shield P slides from position P1 to P2, wherein the gas outlet hole 424 is connected the ambient environment. The compressor 410 comprises a shaft 411, a spring 413 and a piston 416 pushing gas into the gas pipeline 415. Alternatively, the compressor 410 can comprise a cylinder pushing gas into the gas pipeline 415. Liquid cleaner can be directly filled into the liquid reservoir 430. Alternatively, liquid cleaner can be packaged in a refill package and put in the liquid reservoir 430.

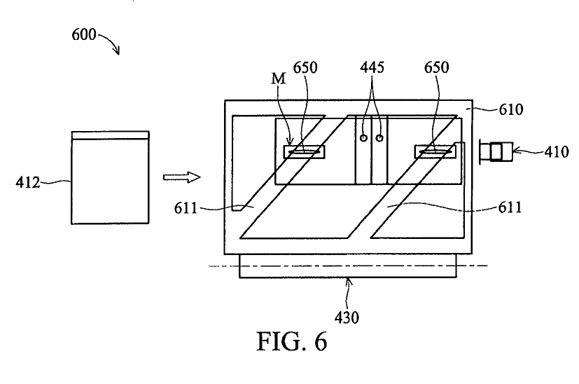

FIG. 6 is a schematic view of an embodiment of the fluid injector device integrating a maintenance apparatus. Compressor 410, liquid reservoir 430 and nozzle 445 are fixed in a base 610 of a fluid injecting device. In FIG. 6, a fluid injector 412 can glide on a rail (not shown) along the direction indicated by an arrow. A wiping device M comprises at least one wiping blade 650 and a rail 611 for wiping blade 650 gliding. When the fluid injector 412 moves above the base 610, the fluid injector 412 drags the wiping blade 650 gliding over a surface of the fluid injector 412.

The base 610 accommodates the compressor 410, the gas pipeline 415, the nozzle 445 and the wiping device M. The liquid reservoir 430 can also be disposed beneath the base 610. Note that the disclosed embodiments of the invention only illustrate the relative arrangement of the fluid injector device integrating a maintenance apparatus, however, the invention is not limited thereto. It should be appreciated by those skilled in the art that other arrangements of the fluid injector device are also applicable.

In one embodiment of the invention, during ordinary printing steps, fluid injector 412 has a shorter distance on the rail and does not touch the compressor 410. Liquid cleaner would not be applied to the fluid injector 412, only the wiping blade is dragged over the fluid injector 412. On the other hand, when ink residue, dust, or other contamination is detected on the surface of the fluid injector, special cleaning maintenance is required to activate the surface of the fluid injector. The fluid injector will travel a longer distance on the track and trigger the compressor 410 such that not only is liquid cleaner ejected and applied on the fluid injector, but the wiping blade is also dragged over the fluid injector. Thus, the fluid injector is maintained more efficiently.

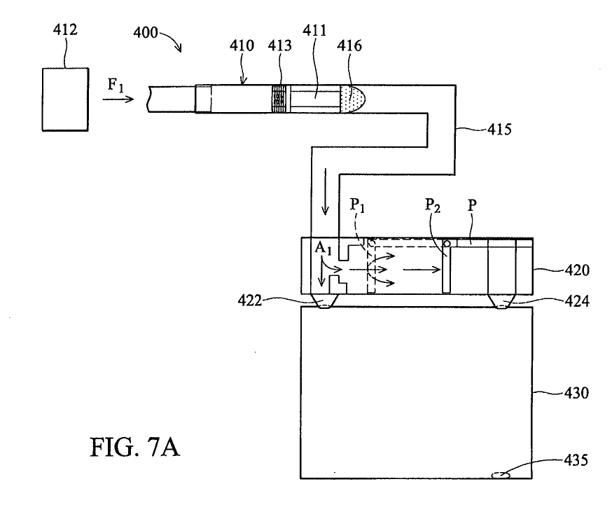

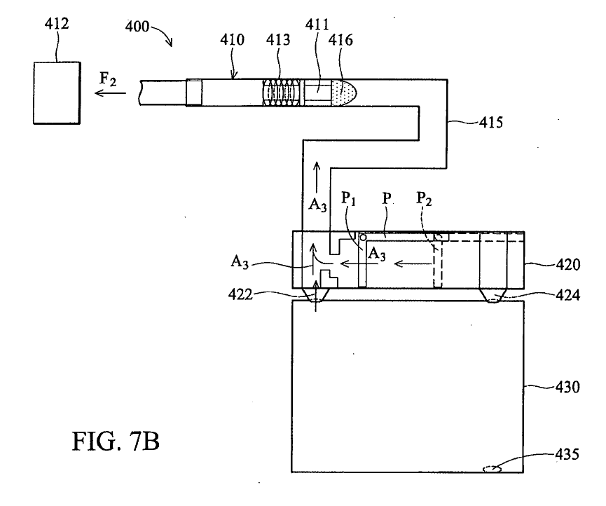

FIGS. 7A-7B are schematic views showing the steps of the compressor pushed by the fluid injector. Referring to FIG. 7A, when the compressor 410 is pushed by the fluid injector, a force F1 acts on piston 416, and spring 413 is compressed simultaneously. Further, the stroke of piston 416 compresses gas in the gas pipeline 415 such that gas flows along the gas pipeline 415 (Arrow A1) into the liquid reservoir 430 through gas inlet hole 422. The glide shield P simultaneously slides from position P1 to P2. Therefore, the gas outlet hole is blocked by the glide shield P, and thereby isolated from the environment. Liquid cleaner in the liquid reservoir 430 is compressed and ejected on the fluid injector through the nozzle 445.

Next, referring to FIG. 7B, when the fluid injector 412 is far away the compressor 410, a resilient force F2 from compressed spring 413 pushes the piston 416 to the original position. During resilience, gas flows along the gas pipeline 415 (Arrow A3) from the liquid reservoir 430 through gas inlet hole 422. The glide shield P simultaneously slides from position P2 to P1. Therefore, the liquid reservoir 430 is connected to the environment through the gas outlet hole 424 to prevent liquid cleaner flow back.

According to the invention, a multi-mode maintenance mechanism is provided using a spring/piston apparatus driving liquid cleaner without requiring additional driving motor and rotation shaft. Note that, liquid cleaner can be pure water or neutral liquid. Alternatively, liquid cleaner can preferably be hydrophobic liquid. For fluid injector applied hydrophobic material, the hydrophobic liquid cleaner can become more advantageous. The liquid reservoir can comprises a single or multiple compartments for holding different liquid cleaners.

The invention can optionally provide built-in software control the fluid injector for selection between multiple modes depending upon operation conditions. For example, a printing control unit comprises an automatic mode and a manual mode. When a printer is initially used, ink can be dried or precipitated on the surface. An intensified maintenance mode is required to remove the ink residue. Alternatively, when a large amount is printed, nozzle may also be clogged by ink residue. An intensified maintenance mode is therefore required to remove the ink residue.

Moreover, the fluid injection device integrating a maintenance apparatus can optionally comprise a sensor such as an optical sensor to analyze surface conditions of the fluid injector. For example, ink precipitants and ink residue may cause surface morphology or electric characteristics to change. Therefore, analysis of the fluid injector according to the flowchart of FIG. 2 is required before printing. A controller for the sensor can be further built-in to the control unit of the fluid injection device integrating a maintenance apparatus.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A maintenance apparatus for a fluid injector, comprising:
a compressor;
a reservoir comprising a gas inlet hole, a gas outlet hole, and a liquid outlet hole, wherein the gas inlet hole connects the compressor via a gas pipe;
a nozzle connecting the liquid outlet hole by a liquid pipeline; and
a wiping device comprising at least one wiping blade and a rail for the at least one wiper to slide on to maintain the nozzles of the fluid injector.

2. The maintenance apparatus as claimed in claim 1, further comprising a base to receive the compressor, the gas pipeline, the liquid pipeline, the nozzle, and the wiping device.

3. The maintenance apparatus as claimed in claim 1, wherein the compressor comprises a back and forth device with a piston and a spring.

4. The maintenance apparatus as claimed in claim 1, wherein the compressor comprises a back and forth device with a cylinder.

5. The maintenance apparatus as claimed in claim 1, wherein the reservoir comprises a natural liquid or a hydrophobic liquid.

6. A fluid injection device integrating a maintenance apparatus, comprising:
a fluid injector;
a rail for back and forth movement of the fluid injector;
a compressor disposed at one end of the rail;
a reservoir comprising a gas inlet hole, a gas outlet hole, and a liquid outlet hole, wherein the gas inlet hole connects the compressor via a gas pipeline;
a nozzle connecting the liquid outlet hole by a liquid pipeline;
a wiping device comprising at least one wiping blade and a rail on which the at least one wiping device slides to maintain the nozzles of the fluid injector; and
a base to receive the compressor, the gas pipeline, the liquid pipeline, the nozzle, and the wiping device.

7. The fluid injection device as claimed in claim 6, further comprising a sensor to analyze a surface of the fluid injector.

8. The fluid injection device as claimed in claim 6, wherein the sensor comprises an optical sensor.

9. The fluid injection device as claimed in claim 6, wherein the compressor comprises a back and forth device with a piston and a spring.

10. The fluid injection device as claimed in claim 6, wherein the compressor comprises a back and forth device with a cylinder.

11. The fluid injection device as claimed in claim 6, wherein the reservoir comprises a natural liquid or a hydrophobic liquid.
